(19) United States
(12) Patent Application Publication
(10) Pub. No.: US 2024/0193700 A1
(43) Pub. Date: Jun. 13, 2024

(54) Single-entry accounting methods and systems that enable users without knowledge of accounting to accurately journalize business transactions and account for assets, liabilities, revenues, and expenses based on user transaction detail choices

(71) Applicant: Daniel D Selby, Midlothian, VA (US)

(72) Inventor: Daniel D Selby, Midlothian, VA (US)

(21) Appl. No.: 18/064,865

(22) Filed: Dec. 12, 2022

(51) Int. Cl. G06Q 40/12; G06F 40/18

(52) U.S. Cl. CPC G06Q 40/123; G06F 40/18

(57) ABSTRACT

Many small business owners do not possess the knowledge of accounting to keep accurate records of business transactions and to file reliable and timely tax returns. A general solution to this problem is disclosed that empowers business owners to supplement their accounting knowledge gap without the need to hire outside experts such as bookkeepers and/or certified public accountants (CPAs)

### BACKGROUND OF THE INVENTION

According to the IRS, annually, there are fifty-eight million business tax return filers in the United States (IRS 2022a). The IRS also states that, annually, only eighty-four percent of those tax returns, including business tax returns, are voluntarily filed on time (IRS 2019a). Ideally, the IRS would welcome one-hundred percent compliance. Therefore, it is reasonable to presume that many delinquent and unfiled tax returns involve small and medium sized businesses. So, an investigation that explains the reasons for unfiled and delinquent small and medium sized business tax return filings is worthy of attention. More directly, a study that investigates tax compliance influenced by accounting, access to accounting reports, and ability to perform accounting has even more merit than the aforementioned study (Kamleitner, et al. 2010). Surprisingly, the tax compliance behavior of small and medium sized business owners has received very little attention in the academic literature. A limited number of studies, however, have analyzed the impact of accounting on business success as the abstract-level dependent variable measured at the concrete-level as profitability. For example, Chelimo and Sopia (2014) concluded that small and medium sized business entity profitability and business growth is affiliated with business owner use of double-entry accounting systems. Evans, et al. (2005), however, did conclude that recording business transactions does impact business owners' ability to comply with tax laws. Their study is limited in that the results are based on business owners' self-assessment of their business success.

Theory on the effects of accounting on tax compliance behavior is needed. It is reasonable to theorize that small and medium sized business owners would be able to file their tax returns on-time and accurately if they could produce their accounting reports on their own. As it stands, small and medium sized business owners encounter difficulty producing their own accounting information because they tend to lack accounting knowledge. Relying on accountants and bookkeepers to produce their accounting reports can lead to delinquent tax return filings. There are existing accounting software tools currently and readily available to small and medium sized business owners but many of these tools require knowledge of accounting. A tool made available to small and medium sized business owners that would enable them to produce their own accounting reports faster and accurately without accounting knowledge may empower them to avoid delinquent and unfiled tax returns.

There are many current anecdotal reports on the impacts of accounting on small and medium size business owner tax compliance. O'Connell (2022) reports delinquent and unfiled tax returns, including business tax returns, result in four hundred-ninety million dollars annually of uncollected taxes. Krause (2021) attribute the delay in tax return filings to the business owner inability to perform accounting. Krause also adds that equipping business owners with the ability to perform their accounting may mitigate uncollected business taxes.

First, many scalable and small business owners do not want to bear the cost of procuring a bookkeeper during the year, so they resort to throwing their business expense receipts into folders and shoe boxes (Gregory 2021). They eventually get around to tabulating their receipts or hand those folders and shoe boxes to their tax preparer when it is time to file their returns. Tabulating a year's worth of business transactions after the business year has ended is very time consuming for whoever tabulates the business transactions so the tax returns can only be completed after the tabulation (Gregory 2021). The result tends to be a late tax return filing.

Second, by the time the old business expense data is analyzed for accounting purposes, the business owner, in most cases, cannot recall the explanation for the receipt or the printing on the receipt has faded and is unreadable. Although there are electronic receipts that will provide dollar amount and itemized lists, that is not enough information to accurately document the transaction. This leads to inaccurate and unreliable reports that are starting point for the return. The time the business owner or tax preparer have to spend when investigating the expense can also delay the preparation of the tax return (Tanski-Phillips 2022).

Third, some business owners do put forth the effort to digitize their expense receipts and may also subscribe to accounting software that will allow them to download their transaction feeds from their bank then select the financial statement line items to record their transactions. Many CPAs have observed many instances where the business owner does not possess the required skills to make correct selections when journalizing their business transactions (Tanski-Phillips 2022; Marquit 2022). The software will require the business owner to make accounting choices. Once the item is recorded incorrectly, the software perpetuates the error by influencing the user to repeat the same incorrect step over and over again when the same business transaction subsequently appears in their bank feed. If the software is easy to use, the business owner may be able to mitigate a late or unfiled business tax return (Tanski-Phillips 2022). Accounting software that would also provide accuracy without knowledge of accounting would be a significant contribution. This is not the state of most current accounting software even though the accounting system is the engine that feeds knowledge to the business owner and enables their ability to comply with tax authorities (IRSb 2022; IRSc 2022).

Fourth and finally, some business owners are proactive enough to purchase a subscription to accounting software and also hire a bookkeeper. But the problem here is that the bookkeeper, regardless of their accounting skills, may not know enough about the business transaction to accurately journalize the transaction (Gregory 2022). The bookkeeper will only have a transaction date, a dollar amount, and sometimes a vendor name but nothing else to rely on other than the business owner's memory recall of the transaction. So, the bookkeeper can either make an assumption where there is the likelihood of an incorrect accounting line item selection or inquire with the business owner in order to resolve the transaction in question. Potentially, enough time can elapse where the business owner may not be able to accurately recall the transaction no better than if the transaction was a stale receipt in a shoe box (Beavers 2022; Gregory 2022; Marquit 2022). The business owner, when equipped with an intelligent but easy to use accounting tool, may be in a position to outperform the skilled accountant.

The methods and systems disclosed address the dual problem of accounting knowledge gaps by business owners and transaction detail knowledge gaps of their bookkeepers. Business owners, when acting in a timely manner, are very likely to possess full knowledge of their business transactions while not possessing knowledge of accounting. When presented with an accounting system that is easy to use and embedded with enough intelligence to perform the accounting that is necessary the business owner can thrive. That is, the methods and systems where business owners can input details about each business transaction then methods and systems journalize each of their transactions on their behalf is the aim of the proposed invention.

### REFERENCES

Beavers, James. “Accountant's Errors Are Not Reasonable Cause for Late Filing.” The Tax Advisor, 1 Apr. 2022, https://www.thetaxadviser.com/issues/2022/apr/accountants-errors-not-reasonable-cause-late-filing.html.
Chelimo, Joseph, and Isaac O. Sopia. “Effects of Bookkeeping on Growth of Small and Medium Business Enterprises in Kabarnet Town, Baringo County, Kenya.” International Journal of Science and Research, vol. 3, no. 12, December 2014, pp. 432-437.
Evans, Chris, et al. “Record Keeping Practices and Tax Compliance of SMEs.” eJournal of Tax Research, vol. 3, no. 3, December 2005, pp. 288-334.
Gregory, Alyssa. “Mistakes Small Business Owners Make When Filing Taxes.” Thebalancemoney.com, 20 Apr. 2021, https://www.thebalancesmb.com/small-business-taxes-mistakes-2951872.
Internal Revenue Service. “IRS Releases New Tax Gap Estimates; Compliance Rates Remain Substantially Unchanged from Prior Study.” 26 Sep. 2019a. https://www.irs.gov/newsroom/irs-releases-new-tax-gap-estimates-compliance-rates-remain-substantially-unchanged-from-prior-study.
Internal Revenue Service. “2019 Small Business/Self Employed Annual Report.” https://www.irs.gov/pub/irs-pdf/p5409.pdf. Accessed 14 Sep. 2022a.
Internal Revenue Service. “Recordkeeping.” https://www.irs.gov/businesses/small-businesses-self-employed/recordkeeping. Accessed 14 Sep. 2022b.
Internal Revenue Service. “Use of Electronic Accounting Software Records; Frequently Asked Questions and Answers.” https://www.irs.gov/businesses/small-businesses-self-employed/use-of-electronic-accounting-software-records-frequently-asked-questions-and-answers. Accessed 14 Sep. 2022c.
Kamleitner, Bernadette. “Tax Compliance of Small Business Owners: A Literature Review and Conceptual Framework.” International Journal of Entrepreneurial Behavior & Research. Vol 18, no. 3, 2012, pp. 330-351. http://dx.doi.org/10.1108/13552551211227710.
Krause, Chelsea. “What Information Does My Accountant Need To Prepare My Tax Return?” Merchant Maverick.com. 17 Nov. 2021, https://www.merchantmaverick.com/what-information-do-i-need-to-bring-my-accountant-to-file-small-business-taxes/.
Marquit, Miranda. “What To Do When You're Not Ready to File Taxes.” Due.com. 23 Jan. 2022, https://www.merchantmaverick.com/what-information-do-i-need-to-bring-my-accountant-to-file-small-business-taxes/.
O'Connell, Brian. “Why Do SO Many People Fall Behind on Their Taxes?” Investopedia.com. 31 Jul. 2022, https://www.investopedia.com/articles/personal-finance/021214/why-do-so-many-people-fall-behind-their-taxes.asp.
Tanski-Phillips, Maria. “6 Tips on How to Improve Financial Reporting Processes.” Patriotsoftware.com. 6 Sep. 2022, https://www.patriotsoftware.com/blog/accounting/improve-financial-reporting-processes/.

### SUMMARY OF THE INVENTION

Many business owners do not possess knowledge of accounting while possessing timely knowledge of their business transaction details. As a result, some business owners hire bookkeepers to supplement their accounting knowledge gap. Their bookkeepers, however, may possess knowledge gaps in business transaction details that prevent the accurate accounting of business transactions. In addition, business owners' memories of business transaction details can fade over time rendering business owners' incapable of supplementing the aforementioned knowledge gap of their bookkeepers. Given business owners' ability to later explain business transactions to their bookkeepers, the time duration between the occurrence of the business transaction event and the hiring of a bookkeeper may also prevent the accurate reporting of business transactions. The result is inaccurate accounting reports that mitigate optimal business management decisions along with inaccurate and untimely business tax filings. A general solution to this problem is disclosed that empower business owners to supplement their accounting knowledge gap without hiring or relying on the services of bookkeepers.

### BRIEF DESCRIPTION OF DRAWINGS

The invention will be more readily understood with reference to the accompanying drawings, wherein:

FIG. 1: shows the flowchart of user input and algorithm to produce final accounting figures

### DETAILED DESCRIPTION OF THE INVENTION

The Microsoft Excel Spreadsheet contains an input screen to record transactions. Transaction number, transaction date, document source, transaction description, and document references (e.g., check numbers, invoice numbers, etc.) are details that can be populated on each row when a transaction is entered. Users will be able to add reference document codes for each transaction. For example, if the user records an accounts receivable transaction, the invoice number can be used as a tag for the transaction. When full or partial payments are later received on that invoice, the invoice number can be entered again on another row so that the user will be able to track whether the invoice has been paid in full.

At the conclusion of user input of all transactions, an income statement is generated that allows users to report prime costs (direct materials+direct labor) in addition to costs grouped by purpose (Customer Relationship Management, Direct Labor Fringe) for each business service/product line to allow for the calculation of Contribution Margin. Fixed Operation Overhead is then captured so that Gross Margin can be determined. The income statement format in this system then goes on to capture additional value-adding costs that are also grouped by purpose (New Business Development, Advertising, Bid & Proposal, Pro-bono Services, Public Relations, New Hire Recruiting, continuing professional education, conference & seminars, Compliance/Licensing, Office, Leadership & Board of Director Meetings, Research & Development). Unlike other systems, this income statement in this system will provide a line item for Activity Based Margin. Therefore, this system is unique in that it will allow for the calculation of Contribution Margin, Gross Margin, and Activity Based Margin. These margin line items are what makes the system compliant with multiple bodies of accounting (e.g., IRC, GAAP, and activity based). All aforementioned line items are referred to as Value Added line items. All remaining line items are captured Non-Value Added line items such as, other income, interest expense, miscellaneous expense, State and Local Taxes (SALT), and Federal Taxes. The income statement concludes with Net Income After Taxes.

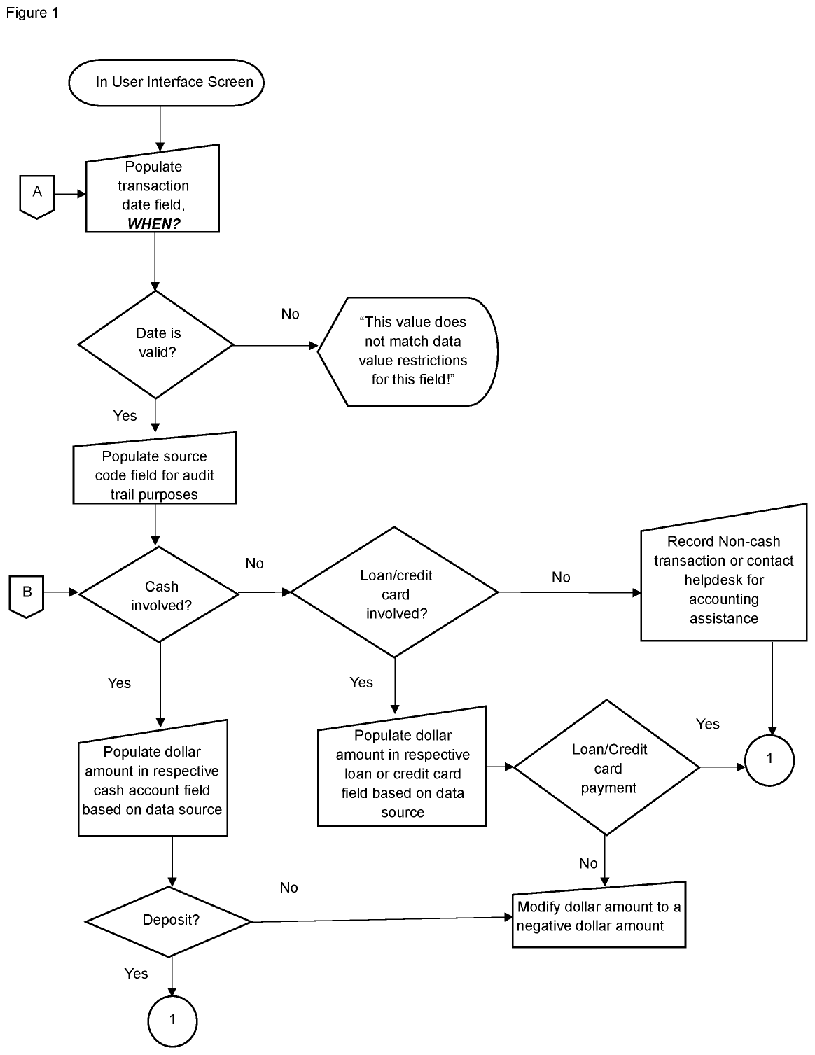

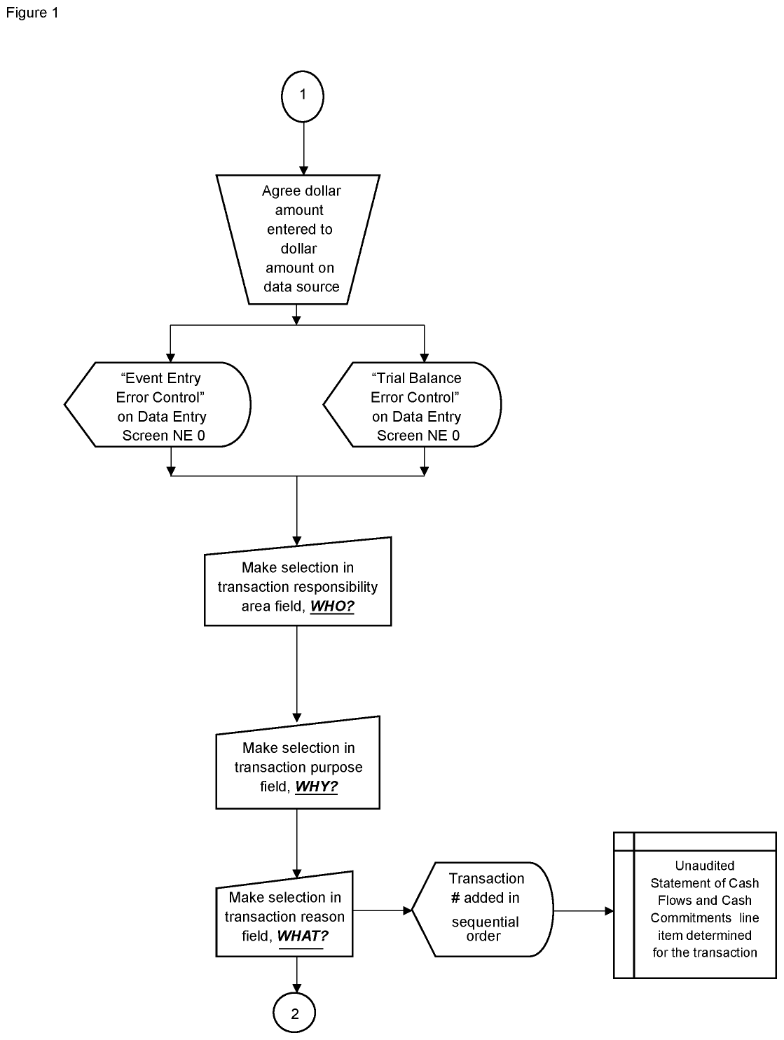

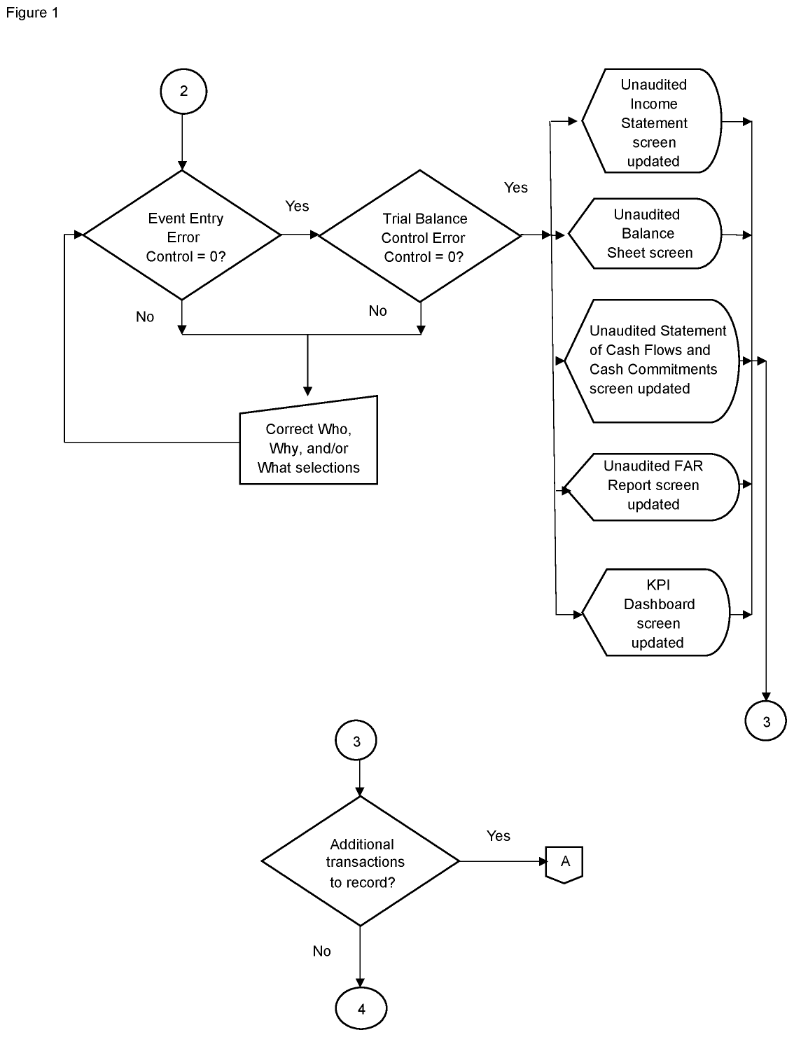

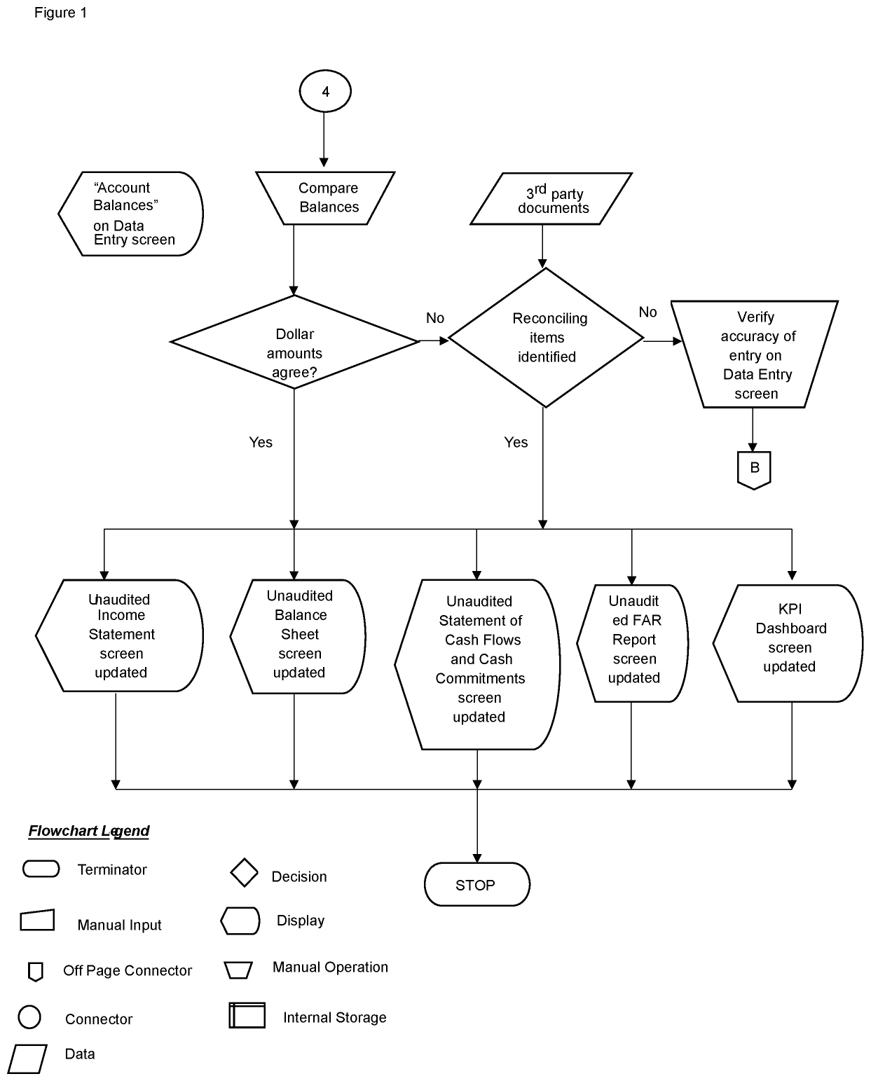

FIG. 1 is a flowchart of the input and resulting outputs of the accounting algorithm. The novel entry screen prompts the user to record a transaction. When each transaction is recorded, the user will indicate which area is responsible for the transaction (Transaction Responsibility), why the transaction occurred (Transaction Purpose), and describe what the transaction is (Transaction Reason). Transaction Responsibility is the data entry field that allows the user to specify which area is responsibility for the transaction. Businesses have different areas of responsibility that could be based on business segment, product line, service line, country, location, business unit, etc. Therefore, transaction responsibility can vary depending on the preferences of the business owner when their system is customized during setup. Transaction Purpose is the data entry field that allow the user to capture “why” the transaction occurred. For example, if the transaction occurred for the purpose of new business development, compliance & licensing, bid & proposal, labor cost, recruiting new hires, this system will allow the user to specify. Transaction Reason is the data entry field that allow the user to capture, at the lowest level of detail, a description of what occurred during the transaction. For example, the transaction could be a payment for a loan principal, loan interest payment, office rent, revenue from a recurring client, etc.

After transaction details are indicated, the source code, a human-readable text written in a specific programming language, processes user inputs regarding transaction responsibility, transaction purpose, and transaction reason to perform the accounting functions on behalf of the user. The system will also process user inputs for the purpose of categorizing the transaction and amounts for financial statement reporting, FAR (Federal Acquisition Regulations) reporting, and a Key Performance Indicator (KPI) dashboard.

The novelty in this accounting algorithm is the Entry Screen that prompts the user to input transactions with minimal accounting knowledge, an automatically generated FAR report to submit to government agencies, and the KPI dashboard, as described in the claims.

1. A computer implemented financial accounting algorithm, implemented on a spread sheet platform having a functional code embedded therein adapted to be executed to implement a method for generating and outputting a key performance indicator dashboard, statement of cash flows and cash commitments, income statement, balance sheet, and Financial Acquisition Report (FAR), and said method comprising: providing the Microsoft Excel program, wherein the spreadsheet comprises a functional code being executed to provide the following functionalities: (1) an input screen where an account balance appears at the top of the columns. The economic impact of each recorded transaction on the trial balance is transparent because the account balance is the summation of all amounts entered in their respective columns that represent either a balance sheet account balance or an income statement account balance; (2) Direct method cash flow statement automation where the system automatically updates Cash Flow Statement Activity Code as O (Operating), I (Investing), or F (Financing) every time a transaction is entered that involves a cash receipt (+) or cash disbursement (−). Each row has a Cash Code Control that will signal a Cash Flow Statement Activity Code; (3) A control embedded at the top of the spreadsheet that signals trial balance error differences so that compliance with the accounting equation, Assets=Liabilities+Capital is transparent, referred to as the Trial Balance Error Control, a sum of all account balances; (4) A Journal Entry Control that signals any violation of double-entry accounting. This control is a summation of all dollar amounts in each row; (5) A Reference Document Control tag embedded for specified accounts to allow the user to enter a document number reference (e.g. invoice number) should be entered on the row for audit trail purposes; (6) Output of Income Statement presented in a proprietary format that is compliant with Internal Revenue Code (IRC), Generally Accepted Accounting Principle (GAAP), and Activity-Based Accounting settings for each product/service line within a business.

2. The computer implemented financial accounting algorithm according to claim 1 further comprising: a report of direct and overhead expenses based on Federal Acquisition Regulations (FAR) for submission to government municipalities and agencies.

3. The computer implemented financial accounting algorithm according to claim 1 further comprising: Key Performance Indicator (KPI) screen used to report metrics on sustainability, viability, revenue growth, loan/funding attractiveness, Federal and State business income tax liability estimate, and overhead expense rate that allows users to monitor cash flow generation and revenue growth and to view projected overhead rate and income tax liability exposure based on the totality of transaction inputs.
